(19) United States
(12) Patent Application Publication
(10) Pub. No.: US 2004/0224584 A1
(43) Pub. Date: Nov. 11, 2004

(54) Facing sheet of open mesh scrim and polymer film for cement boards

(75) Inventor: Andrew Broadway, Anderson, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: TechFab, LLC - Anderson, SC

(21) Appl. No.: 10/434,003

(22) Filed: May 8, 2003

(51) Int. Cl. B32B 27/04; B32B 13/14; B32B 13/02; B32B 5/26; B32B 27/12

(52) U.S. Cl. 442/38; 442/42; 442/20; 442/32

(57) ABSTRACT

There is provided a facing sheet for cement boards comprising a scrim and polymer film. The scrim has a plurality of intersecting yarns defining an open mesh pattern with an inner face defining a grid profile for mechanical interaction with the cementitious composition of the cement board. The polymer film is joined to an outer face of the scrim and defines a repeating pattern of openings. The polymer film facilitates the mechanical interaction between the grid profile of the scrim and the cementitious composition and allows the passage of moisture from the cementitious composition during hardening of the cement board. The scrim may include glass fibers yarns and the polymer film may be formed by a gravure rolling process. A cement board may include a second facing sheet on a surface opposite the first facing sheet.

### FIELD OF THE INVENTION

The present invention relates generally to facing sheets for cement board products. More particularly the invention relates to facing sheets that include an open mesh scrim joined with a polymer film that has a repeating pattern of openings such that the polymer film facilitates the mechanical interaction of the scrim and the cementitious composition.

### BACKGROUND OF THE INVENTION

Cement boards and other types of construction boards are used in a variety of structural applications. Cement boards are used as a support surface for overlying materials such as tile, brick, stucco, wood siding, marble, and the like. Cement boards are also used in exterior insulating systems, commercial roof deck systems, and exterior curtain walls. Cement boards typically include a core of cementitious composition interposed between facing sheets. The facing sheets provide flexural and impact strength to the cementitious core that typically consists of a brittle material with high compressive strength. The facing sheets may also provide a durable protective layer or other desirable surface properties to the cementitious core.

Facing sheets can include multiple layers to achieve the desired structural properties and surface properties for the particular cement board. U.S. Pat. No. 4,504,533 to Altenhöfer et al. discloses a gypsum construction board with a two-layer facing sheet comprising a glass fiber web and a fiberglass non-woven layer that are adhered together. The glass fiber web is embedded in the gypsum core, yet the fiberglass non-woven layer prevents or hinders the passage of gypsum through the non-woven layer, though the gypsum may penetrate slightly into the non-woven layer. The fiberglass non-woven layer may include materials such as mineral fibers, glass fibers, or cellulose fibers. However, such an exterior surface may provide inadequate or undesirable surface properties.

An alternative facing sheet may include an outer layer that facilitates the interaction of the core material with the inner layer of the facing sheet. U.S. Pat. No. 6,054,205 to Newman et al., discloses a facing sheet that includes a glass fiber scrim with a layer of melt blown polymer applied to the surface of the scrim opposite the cementitious core. The glass fiber scrim is integrated into the cementitious core during the manufacturing process to increase the bond strength between the cementitious core and the facing sheet. The melt blown polymer improves the outer surface of the cement board by increasing the distribution of the cementitious composition within the mesh of the scrim, thus reducing pits in the outer surface.

Melt blowing hot polymer onto a scrim can be a costly and complex manufacturing process. Melt blown processes often require expensive equipment and may also require time-intensive production cycles. Furthermore, achieving a repeatable and uniform surface quality with a melt blown process can be challenging. Therefore, a need exists for a cement board facing sheet that provides desirable surface properties and that is economically, conveniently, and consistently manufactured.

### BRIEF SUMMARY OF THE INVENTION

The invention addresses the above needs and achieves other advantages by providing a facing sheet for objects comprising a hardened cementitious composition. The facing sheet includes a scrim and a polymer film. The scrim has a plurality of intersecting yarns that define an open mesh pattern. The scrim also has an inner face and an outer face, such that the inner face of the scrim defines a grid profile for mechanical interaction with the cementitious composition. The polymer film defines a repeating pattern of openings. The polymer film is joined with the outer face of the scrim, and when the facing sheet is applied to the cementitious composition, the polymer film facilitates mechanical interaction between the scrim and the cementitious composition as the cementitious composition hardens.

One embodiment of the facing sheet includes a scrim comprising yarns of glass fiber that are joined at their crossover points with a polymeric binder. The scrim can have less than 155,000 mesh openings per square meter. The polymer film of the facing sheet can comprise a thermoplastic material or a thermoset polymer and can be a gravure printed film. The polymer film can be joined to the scrim to form the facing sheet prior to the application of the facing sheet to the cementitious composition. The facing sheet could alternatively, however, have the polymer film joined to the scrim during the mechanical integration of the cementitious composition and the scrim.

A cement board is also provided, wherein the cement board has a cementitious core and a facing sheet comprising a scrim and a polymer film. The scrim has a plurality of intersecting yarns defining an open mesh pattern and the polymer film defines a repeating pattern of openings. The polymer film is joined to an outer face of the scrim and the cementitious composition of the cement board core is mechanically integrated to an inner face of the scrim. The polymer film facilitates the mechanical interaction between the scrim and the cementitious composition. The cement board can also include a second facing sheet that is similar to the first facing sheet and is applied to a surface opposite the first facing sheet.

A method for manufacturing a facing sheet for objects comprising a hardened cementitious composition is also provided. A plurality of intersecting yarns are joined to create a scrim defining an open mesh pattern that has an inner face and an outer face. A polymer film is formed to define a repeating pattern of openings. The polymer film is joined to the outer face of the scrim to define the facing sheet. The inner face of the scrim defines a grid profile for mechanical interaction with the cementitious composition.

The method can include the joining of the intersecting yarns with a polymer binder at the crossover points of the intersecting yarns. In addition, the forming of the polymer film can be by a gravure rolling process, wherein a heated polymer is gravure rolled to create the polymer film. The method of manufacturing can also include the transfer of the polymer film from the gravure rolling process onto an intermediate surface and the transfer of the polymer film from the intermediate surface to the scrim. Other methods of manufacturing a facing sheet for objects comprising a hardened cementitious composition are described herein.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of a facing sheet comprising a polymer film and a glass fiber scrim;

FIG. 2 is an enlarged, top view of the facing sheet of FIG. 1;

FIG. 3 is a perspective view of a cement board including the facing sheet of FIG. 1;

FIG. 4 is a sectional view of the cement board of FIG. 3 along the line 4-4;

FIG. 5 is a perspective view illustrating a first method of joining a polymer film formed by gravure rolling to a scrim of glass fiber to form a facing sheet of the present invention;

FIG. 6 is a perspective view, similar to FIG. 5, illustrating a second method of joining a polymer film formed by gravure rolling to a scrim of glass fiber to form a facing sheet of the present invention; and

FIG. 7 is a side view illustrating a method of manufacturing a cement board by separately advancing the scrim and the polymer film.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

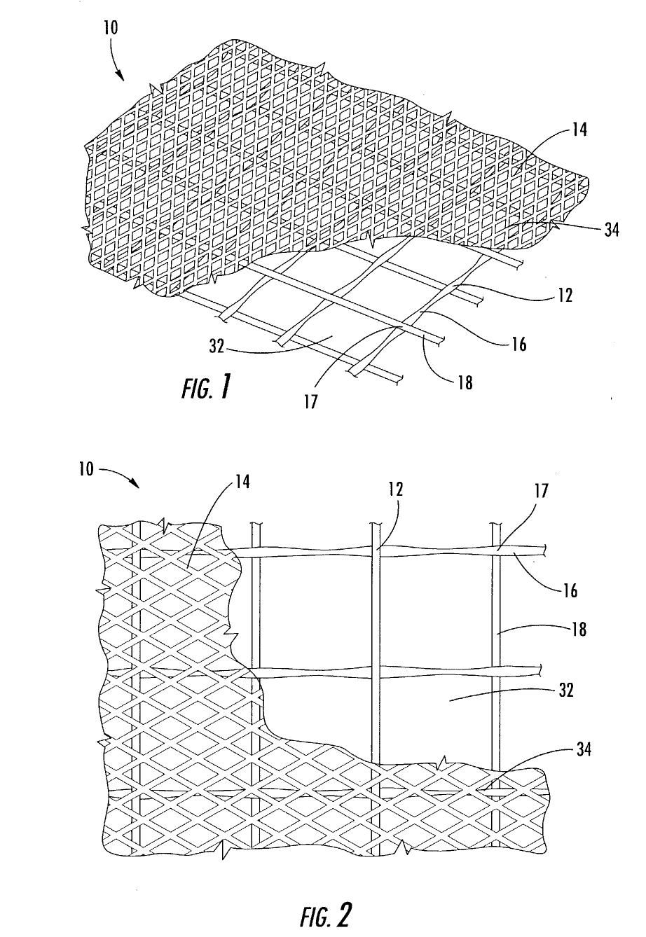

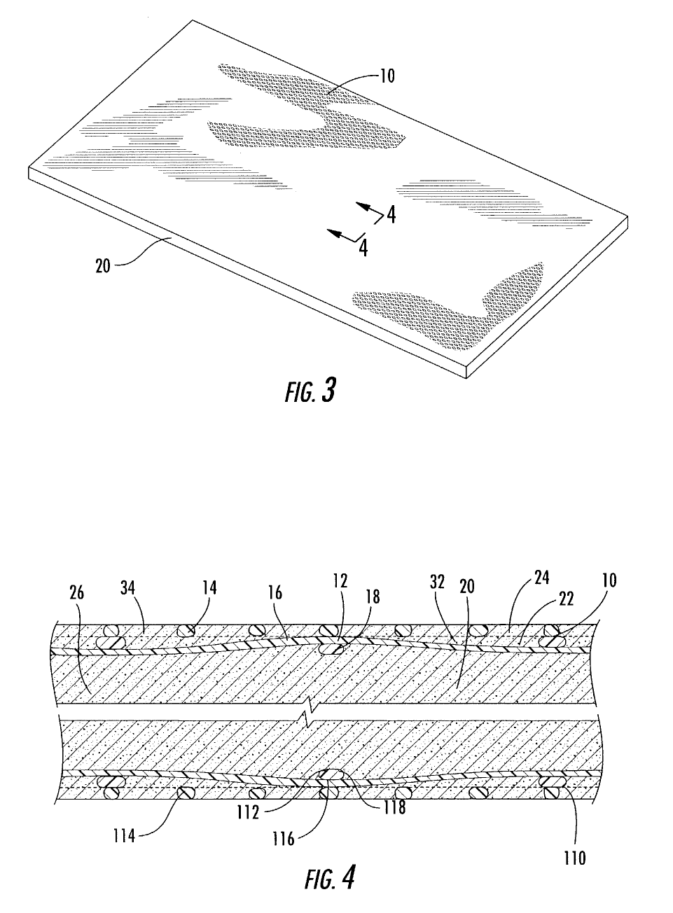

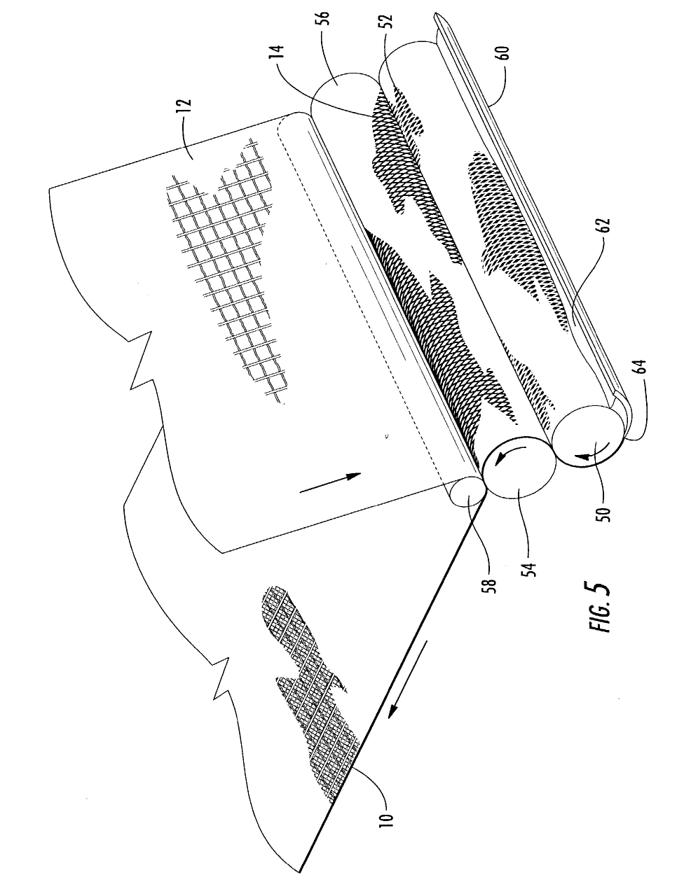

FIG. 1 illustrates a facing sheet 10 formed by a scrim 12 joined to a polymer film 14. The scrim 12 of FIG. 1 and FIG. 2 comprises an open mesh scrim formed by a plurality of intersecting, continuous multifilament, yarns 16 and 18 that are joined at their crossover points 17 and that define mesh openings 32. The polymer film 14 comprises a layer of polymer with a repeating pattern of openings 34. The polymer film 14 and the scrim 12 are joined together to form a facing sheet 10 for a cement board 20, as shown in FIG. 3.

The scrim 12, as shown in FIG. 2, is formed by a plurality of longitudinal yarns 18 and a plurality of transverse yarns 16 that are transverse to the longitudinal yarns. A scrim 12 of glass fiber yarns 16 and 18 is disclosed in U.S. Pat. No. 6,054,205 to Newman et al., the disclosure of which is incorporated herein. The longitudinal yarns 18 of the scrim 12 of FIG. 2 are disposed above or below the transverse yarns 16 in an alternating pattern, such that a crossover point 17 is created at each intersection of a longitudinal yarn and a transverse yarn. The yarns 16 and 18 of FIG. 1 are glass fibers; however, the scrim 10 may alternatively include yarns of various materials, non-limiting examples being carbon fiber, aramid fiber, polymer fiber, and PVA fiber, or the scrim may include a combination of yarn types.

The glass fiber yarns 16 and 18 of FIG. 2 of the scrim 12 are oriented in a perpendicular fashion such that the transverse yarns are angled 90 degrees relative to the longitudinal yarns. Furthermore, the transverse yarns 16 are parallel to one another and the longitudinal yarns 18 are also parallel to one another. The facing sheet 10 may alternatively include yarns in a 0/60/120 degree orientation and/or may include additional sets of yarns such that the mesh openings 32 define equilateral triangles or polygons.

The number of transverse yarns 16 and longitudinal yarns 18 of the scrim 12 may be defined by the number of mesh openings 32 of the scrim. The scrim 12 of FIG. 1 has less than about 100 mesh openings per square inch (i.e., a pick count less than 10 by 10) or 155,000 mesh openings per square meter. Alternatively, the scrim 12 may have less than 70 mesh openings per square inch, or approximately 108,500 mesh openings per square meter or even less than 50 mesh openings per square inch, or approximately 77,500 mesh openings per square meter. Generally, the individual yarns 16 and 18 used to form the scrim can have a size ranging from about 900 yds/lb, or 1,800 m/kg, to about 9,000 yds/lb, or 18,000 m/kg. In addition, the cross-sectional shape of the yarns 16 and 18 may include flat and curved surfaces, as shown in FIG. 4, or alternatively may be circular, elliptical, or polygonal to list a few non-limiting examples of shapes.

The scrim 12 of FIG. 2 includes glass fiber yarns 16 and 18 joined at their crossover points 17 to provide dimensional stability for the scrim. This dimensional stability of the scrim 12 provides further dimensional stability and reinforcement to the subsequently manufactured cement board 20 to which the scrim is applied. The crossover points 17 of the scrim 12 of FIG. 2 may be bonded with a polymer binder, such as polyvinyl chloride (PVC) applied as a plastisol, though the polymer binder can be any bonding material. Alternatively, the yarns 16 and 18 may be joined without the use of bonding materials, such as weaving the yarns into a woven scrim, to name one non-limiting example. The scrim 12 may also include an alkali and moisture resistant thermoplastic or thermosetting polymer coating that prevents chemical interaction between the cementitious composition 26 of the cement board 20 and the glass fiber yarns 16 and 18 once the scrim is applied to the cementitious composition as illustrated in FIG. 4. The scrim 12 may alternatively include additional manufacturing techniques or materials to bond or coat the yarns 16 and 18.

The scrim 12 of FIG. 1 has an inner face and an outer face. The inner face of the scrim 12 defines a grid profile for mechanical interaction with the cementitious composition 26, as shown in FIG. 4. The grid profile defines mesh openings 32 into which the cementitious composition 26 flows and contacts the edges of the grid profile during the manufacture of the cement board 20. Such mechanical interaction between the cementitious composition 26 and the scrim 12 increases the bond strength between the two and thus increases the overall strength of the cement board 20 after hardening. The outer face of the scrim 12 is on a side opposite the inner face and defines a surface to which a polymer film 14 is joined, such that the polymer film facilitates the mechanical interaction between the cementitious composition and the scrim.

The polymer film 14, of the facing sheet 10 shown in FIG. 1 and FIG. 2, comprises a layer of gravure rolled polymer with a repeating pattern of openings 34. The facing sheet 10, may alternatively include a polymer film 14 with a repeating pattern of openings 34 manufactured by other methods, such as transfer coating, film slitting, extrusion process, tentered film, or apertured film (heated needles, die punched, etc.). The illustrated polymer film 14 is a polymer netting that includes lines oriented in a +/−45 degree configuration that defines a repeating pattern of quadrilateral shaped openings 34. Distances between the lines of the polymer film 14 that define an opening 34 range from 1 mm to 12 mm; however, the polymer film may alternatively include lines separated by a distance of less than 1 mm. Furthermore, the polymer film 14 may define a repeating pattern of any shaped openings 34 located at any relative distances and do not necessarily require lines to separate the openings. The basis weight of the polymer film 14 of FIG. 1 is approximately 35 grams per square meter, though the basis weight of alternative polymer films may vary from 10 to 60 g/m². The thickness of the polymer film 14 of FIG. 4 is approximately equivalent to the width of the netting lines of the polymer film. Alternatively, the polymer film 14 may be of any thickness relative to the size of the material separating the openings 34.

The polymer film 14 is joined to the outer face of the scrim 12 and defines the outer surface of the facing sheet 10. To provide a rigid and durable outer surface for the cement board 20, the polymer film 14 of FIG. 1 is a thermoplastic material or a thermoset polymer. The illustrated polymer film 14 is made from a polyester hot melt polymer, which provides thermal stability and the ability to retain mechanical properties at relatively high temperatures. However, any polymer material may be used to manufacture polymer film 14. Because the polymer film 14 defines the outer surface of the cement board 20, the polymer provides desirable surface qualities such as a semi-smooth board surface and the ability to be coated or painted.

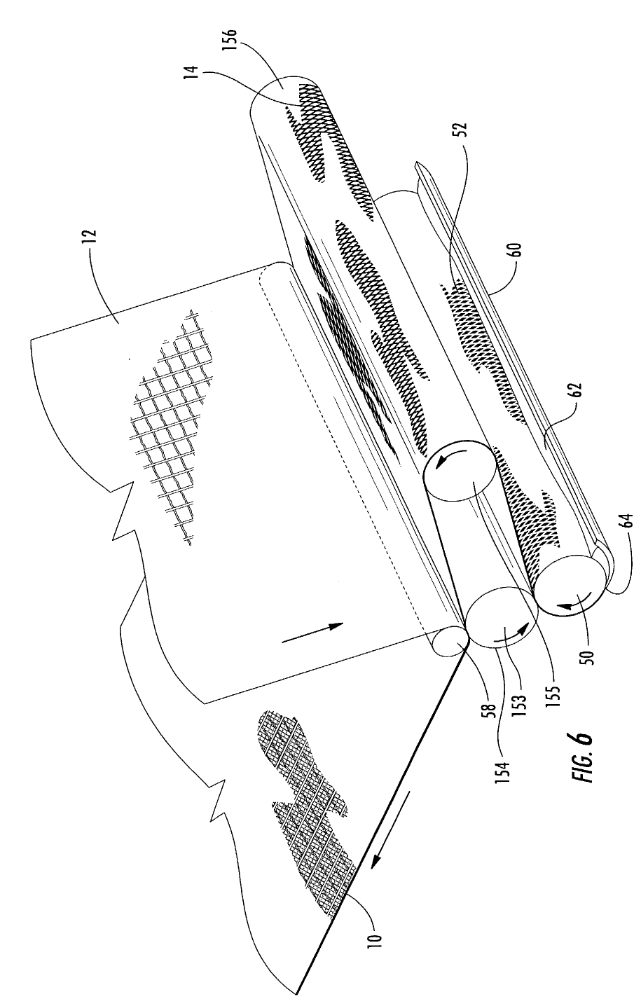

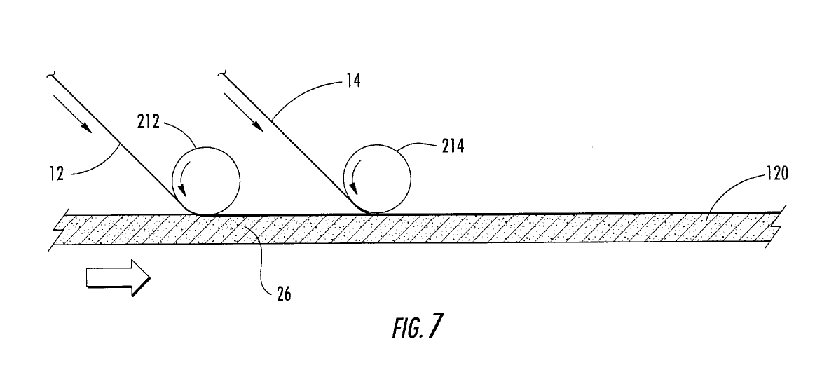

The polymer film 14 of FIG. 5 and FIG. 6 is a gravure printed film manufactured using a gravure rolled process. The polymer material may be transferred to the manufacturing facility in pellet form and then heated to form a heated polymer 62, though other methods of providing a heated polymer may be utilized. The polymer is heated to a temperature such that the heated polymer 62 can be gravure rolled. The heated polymer 62 is transported to a position adjacent the gravure roller 50 and is collected between a dam 60 and the gravure roller, as shown in FIG. 5 and FIG. 6. The dam 60 includes end walls, which are not illustrated, to confine the heated polymer 62 such that the heated polymer may be removed primarily by the gravure rolling process. The lower portion of the dam 60 includes a doctor blade 64 that meters out the heated polymer 62 onto the gravure roller 50 such that the polymer film 14 has a generally constant thickness. The gravure roller 50 is a circular roller of a given radius that includes a plurality of protrusions 52 that extend an equivalent distance in the radial direction.

To form the polymer film 14, the gravure roller 50 is rotated downward on the side facing the dam 60 as shown in FIG. 5 and FIG. 6. The outer surface of the protrusions 52 contact the doctor blade 64 of dam 60 during the rotation of the gravure roller 50. The heated polymer 62 in dam 60 engages all the exterior surfaces of the rotating gravure roller 50 proximate the dam. However, as the gravure roller 50 rotates past the doctor blade 64 the heated polymer 62 contacting the outer surfaces of the protrusions 52 and the heated polymer located at a radial distance approximately equal to or greater than the radial distance of the outer surface of the protrusions is metered away and prevented from following the gravure roller beyond the doctor blade. The heated polymer 62 remaining in contact with the gravure roller 50 beyond the doctor blade 64 is a film of a relatively consistent thickness with voids occupied by the protrusions 52. These voids become the openings 34 of the polymer film 14 after the film is removed from the gravure roller 50. As the gravure roller 50 continues to rotate the film of heated polymer 62 cools to form the polymer film 14.

As shown in FIG. 5, a transfer roller 54 is located proximate the gravure roller 50 and engages the polymer film 14 at the point where the two rollers are closest to each other. The transfer roller 54 of FIG. 5, as well as the transfer belt 154 of FIG. 6, functions as an intermediate surface for transferring the polymer film 14 from the gravure rolling process to the joining process of the polymer film and the scrim 12. As shown in FIG. 5, the polymer film 14 is lifted from the gravure roller 50 and remains engaged to the transfer roller 54 because of the tangential force transmitted through the polymer film from the portion of the polymer film already engaging the transfer roller. The transfer roller 54 includes an outer surface 56 that engages the polymer film 14. The outer surface 56 of FIG. 5 is a smooth, non-stick surface such that when the polymer film 14 is joined to the scrim 12, the polymer film separates easily from the transfer roller 54. A temperature-controlled silicone roller is a non-limiting example of a non-stick transfer roller 54. Therefore, the polymer film 14 remains in contact with the transfer roller 54 only along the arc from the point proximate the gravure roller 50 to the point proximate the scrim roller 58.

Once the polymer film 14 is lifted from the gravure roller 50 onto the transfer roller 54, the surface of the gravure roller along the arc between the transfer roller 54 and the dam 60 does not include a heated polymer 62 or a polymer film 14. The exterior surface of the gravure roller 50 then submerges into the heated polymer 62 of the dam 60 again so that the heated polymer in the dam fully engages all the exterior surfaces of the gravure roller proximate the dam and the process is repeated.

As shown in FIG. 6, a polymer film 14 may be manufactured using a transfer belt 154 rather than the transfer roller 54 of FIG. 5. The transfer belt 154 includes a first roller 153 and a second roller 155 located a certain distance from the first roller. The transfer belt 154 also includes a belt disposed about the two rollers, wherein the belt has a surface 156 for engaging the polymer film 14. The belt engages the first roller 153 and second roller 155 in a tight manner that prevents slippage of the belt relative to either roller and allows the two rollers to maintain a predetermined ratio of rotation speeds. Before the polymer film 14 is transferred to the transfer belt 154 of FIG. 6, the heated polymer 62 is fed on the gravure roller 50 through the doctor blade 64 and cools into a polymer film 14 in a similar fashion as occurs in the process of FIG. 5. By the time the polymer film 14 is rotated to the point of the gravure roller proximate the first roller 153 of the transfer belt 154, the polymer film is sufficiently cooled such that tangential force sufficient to lift the polymer film off the gravure roller does not significantly stretch the polymer film. The cooled polymer film 14 is then lifted from the gravure roller 50 and remains engaged to the transfer belt 154 because of the tangential force transmitted through the polymer film from the portion of the polymer film already engaging the transfer belt. The outer surface 156 of the transfer belt 154 that engages the polymer film 14 of FIG. 6 is a smooth, non-stick surface such that when the polymer film is joined to the scrim 12, the polymer film separates easily from the transfer belt. A Teflon belt is a non-limiting example of a non-stick transfer belt 154.

The polymer film 14 remains in contact with the transfer belt 154 along the path of the belt from the point proximate the gravure roller 50 to the point proximate the scrim roller 58. One advantage of the transfer belt 154 of FIG. 6 is the amount of time provided for cooling the polymer film 14 or for including additional process steps. A non-limiting example of an additional process step is the application of adhesive to the outwardly facing surface of a polymer film 14 that is subsequently joined to the scrim 12. Further methods of transferring the polymer film 14 from the gravure roller 50 to a contact point proximate the scrim roller 58 are not illustrated but may include the use of release paper upon which the polymer film can be temporarily positioned for cooling and transport prior to joining the scrim 12 or may include the direct application of the polymer film from the gravure roller to the scrim, to list two non-limiting examples.

The polymer film 14 is joined to the outer face of the scrim 12 to define the facing sheet 10. The polymer film 14 of FIG. 5 and FIG. 6 is joined to the scrim 12 with the application of heat and pressure such that the material properties of the polymer material are temporarily altered to join the scrim and polymer film. Such a method is illustrated in FIG. 5 wherein the scrim 12 is fed around scrim roller 58 and the polymer film 14 is fed around intermediate roller 54. Scrim roller 58 and intermediate roller 54 are positioned such that the scrim 12 contacts the polymer film 14 at the point where the two rollers are closest to each other. Either roller 58 or 54 may be heated and/or the rollers may be positioned such that pressure is exerted on the scrim 12 and polymer film 14 such that the heat and/or pressure causes the polymer film to be joined to the scrim. Likewise, the first roller 153 of FIG. 6 that is proximate the scrim roller 58 may be heated and/or positioned such that pressure is exerted on the scrim 12 and polymer film 14 such that the heat and/or pressure causes the polymer film to be joined to the scrim. If the polymer film 14 retains a sufficient amount of heat or thermal energy from the gravure rolling process at the time the polymer film is joined with the scrim 12, additional heat may not be necessary to join the polymer film and scrim.

Adhesives may alternatively be applied to the polymer film 14 to join the polymer film to the scrim 12. After the polymer film 14 has been formed but before the polymer film is joined to the scrim 12, an adhesive may be sprayed or coated directly onto the surface of the polymer film that is to be joined to the outer face of the scrim 12. The adhesive, which may be an adhesive of a type typically used for non-woven materials, increases the thickness of the finished facing sheet 10 and improves the bond strength between the polymer film 14 and the scrim 12. Further methods of joining the scrim 12 and polymer film 14 may also be utilized. Once the scrim 12 and polymer film 14 have been joined to form the facing sheet 10, the facing sheet is transported away to be applied onto the cementitious composition or to be stored for subsequent use.

The scrim 12 and the polymer film 14 may also be fed separately to the cementitious composition 26 so that the polymer film and the scrim are applied adjacent to each other and may not permanently join each other until after the cementitious composition has hardened. FIG. 7 illustrates a method of manufacturing a reinforced cement board 120 by advancing the scrim 12 to the cementitious composition 26. A scrim roller 212 is located proximate a surface portion of the cementitious core such that as the scrim 12 is fed around the surface of the scrim roller, the scrim is applied to the surface portion of the cementitious core so that the grid profile mechanically interacts with the cementitious composition 26. A polymer film 14 is then advanced to the cementitious core, such that the film roller 214 applies the polymer film to the surface portion of the cementitious core containing the scrim 12 so that the polymer film engages the scrim and facilitates the mechanical interaction between the grid profile of the scrim and the surface portion of the cementitious composition 26. Alternatively, the scrim 12 and polymer film 14 may be advanced to the cementitious composition by other methods that may not incorporate the scrim roller 212 and/or the film roller 214, respectively. After the scrim 12 and polymer film 14 have been applied to the cementitious composition, the cementitious core may be transferred away for additional operations such as advancing a second scrim and a second polymer film to a surface of the cementitious composition opposite the scrim 12 and polymer film 14 and/or cutting the cementitious composition into discrete cement boards. The polymer film 14 and the scrim 12 of FIG. 7 are joined during the hardening of the cement board 120 by the hardened cementitious composition. Alternatively, the polymer film 14 may be joined to the scrim 12 concurrent with the advancing of the polymer film to the cementitious composition 26.

To form the reinforced cement board 20 of FIG. 3 and FIG. 4, a cementitious composition 26 is mixed using one or more compositions of varying moisture content. Non-limiting examples of cementitious compositions are polymer concrete, aluminous cement, Portland cement, gypsum cements, or mixtures thereof with or without aggregates or polymer binders. While in a relatively liquid state, the cementitious composition 26 is poured or is pressed through rollers to form a continuous board of approximately constant thickness and width. While in the relatively liquid state, the facing sheet 10 of FIG. 2 is positioned proximate a surface portion of the cement board 20 and then applied to the cement board so that the scrim is mechanically integrated into the cementitious composition 26. As shown in FIG. 4, the scrim 12 is applied to the cementitious composition 26 to such a depth that a cementitious composition 22 occupies the mesh opening 32 of the scrim 12. The scrim 12 is mechanically integrated into the cementitious composition 26 by the cementitious composition 22 contacting a substantial surface area of the yarns 16 and 18 of the scrim, such that once the cementitious composition is hardened, the bond strength between the scrim and the cementitious composition is strong. The polymer film 14 of the facing sheet 10 facilitates the distribution of the cementitious composition 22 within the mesh opening 32 of the scrim.

The polymer film 14 may be joined to the scrim 12 either before the scrim is applied to the cementitious composition 26, as shown in FIG. 5 and FIG. 6, or after the scrim is applied to the cementitious composition but before the cementitious composition hardens, as shown in FIG. 7. Alternatively, the polymer film 14 may be joined to the scrim 12 concurrent with the application of the scrim to the cementitious composition such that the force to apply the scrim to the cementitious composition also joins the polymer film to the scrim. Regardless of the relative timing that the polymer film 14 is joined to the scrim 12, the polymer film contacts the cementitious composition 22 that enters the mesh openings 32 of the scrim.

By contacting the cementitious composition 22, the polymer film 14 prevents the cementitious composition from creating convex bulges within the mesh openings 32 and from creating meniscuses within the mesh openings. Convex bulges and meniscuses may each reduce the bond strength between the cementitious composition 22 and the scrim 12 thus reducing the structural strength the facing sheet 10 provides the cement board 20. Furthermore, convex bulges and meniscuses can also create an undesirable surface quality for a cement board 20. The polymer film 14 prevents convex bulges and meniscuses by breaking the surface tension of the cementitious composition 22, thus allowing the cementitious composition to propagate along the grid profile of the scrim 12 and to remain in place while the cementitious composition hardens. Furthermore, the cementitious composition 24 may also propagate into the openings 34 of the polymer film 14 such that the openings are filled with cementitious composition, as shown in FIG. 4. Because the openings 34 of the polymer film 14 are small relative to the mesh openings 32 of the scrim 12, any convex bulges or meniscuses that may appear in the cementitious composition 24 within the openings of the polymer film are of nominal size. Therefore, the outside surface of the polymer film 14 defines a generally smooth surface, as shown in FIG. 4.

The openings 34 of the polymer film 14 are sufficiently large to allow moisture to pass from the cementitious composition 26 of the core of the cement board 20 during the hardening process. This passage of moisture allows the cement board 20 to harden in less time than a cement board with a facing sheet that prevents or hinders the passage of moisture, thus providing for more timely and cost effective manufacture of cement boards.

As illustrated in FIG. 4, a second facing sheet 110 may also be applied to a surface portion of the cement board 20 opposite a first facing sheet 10; however, the cement board may alternatively include no second facing sheet. The second facing sheet 112 of FIG. 4 provides additional structural support for the cement board 20 and improves the surface properties of the cement board surface opposite the first facing sheet 10. The second facing sheet 110 comprises a second scrim 112 and a second polymer film 114. The second scrim 112 comprises a plurality of longitudinal yarns 118 and a plurality of transverse yarns 116 that are transverse to the longitudinal yarns. The second polymer film 114 may be formed by the same process and with the same material as the first polymer film 14. The second facing sheet 110 may be applied to the cementitious composition 26 in a similar manner as the scrim 12 and polymer film 14 of the facing sheet 10. Alternatively, the facing sheet 10 and the second facing sheet 110 may be applied to the same cementitious composition 26 by dissimilar methods, such as pouring the cementitious composition onto the second facing sheet and applying the first facing sheet to a surface portion opposite the second facing sheet, to describe one non-limiting example.

The cement board 20 of a given width and thickness is cut to length once the facing sheet 10 has been fully applied and the cement board has hardened a sufficient amount such that the cutting does not deform the cement board proximate the cut line. A representative size for a cement board 20 is a 4′×8′×7/16″ board, though the board may be formed and cut to any size. Hardening of the cement board involves the passage of moisture from the cementitious composition 26 to the surrounding environment until the cementitious composition is rigid. The hardening process may be accelerated by the application of heat to the cement board 20. Passage of moisture from the cement board 20 is possible through the edges defining the width of the cement board and the edges defining the length of the cement board, after cutting. Moisture passage is also possible through the polymer film openings 34 of the facing sheet 10 such that the cement board 20 hardens more quickly and more uniformly than if moisture passage was limited to the edges.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A facing sheet for an object comprising a hardened cementitious composition, the facing sheet comprising:
a scrim having a plurality of intersecting yarns defining an open mesh pattern, the scrim having an inner face and an outer face wherein the inner face of the scrim defines a grid profile for mechanical interaction with the cementitious composition; and
a polymer film joined with the outer face of the scrim, the polymer film defining a repeating pattern of openings therein, wherein the polymer film facilitates mechanical interaction between the scrim and the cementitious composition as the cementitious composition hardens.

2. A facing sheet according to claim 1, wherein the yarns of the scrim are glass fibers.

3. A facing sheet according to claim 2, wherein the scrim has less than about 155,000 mesh openings per square meter.

4. A facing sheet according to claim 2, wherein the yarns of the scrim are joined at their crossover points by a polymeric binder.

5. A facing sheet according to claim 2, wherein the yarns of the scrim are woven to create the scrim.

6. A facing sheet according to claim 1, wherein the yarns of the scrim are a combination of yarn types.

7. A facing sheet according to claim 1, wherein the polymer film is a thermoplastic material.

8. A facing sheet according to claim 1, wherein the polymer film is a thermoset polymer.

9. A facing sheet according to claim 1, wherein the polymer film is a gravure printed film.

10. A facing sheet according to claim 1, wherein the openings of the polymer film are sufficiently large to allow passage of moisture during the hardening of the cementitious composition.

11. A facing sheet according to claim 1, wherein the basis weight of the polymer film is between about 10 and 60 g/m².

12. A facing sheet according to claim 1, wherein a distance between lines of the polymer film is between about 1 mm and 12 mm.

13. A facing sheet according to claim 1, wherein the polymer film is joined to the scrim with a sprayed adhesive.

14. A cement board, comprising:
a cementitious core formed by a cementitious composition that hardens to define the core; and
a facing sheet that defines at least part of one face of the cement board, said facing sheet comprising;
a scrim having a plurality of intersecting yarns defining an open mesh pattern, the scrim having an inner face and an outer face wherein the inner face of the scrim defines a grid profile; and
a polymer film joined with the outer face of the scrim, the polymer film defining a repeating pattern of openings therein;
wherein the polymer film facilitates mechanical interaction between the grid profile of the scrim and the cementitious composition as the cementitious composition hardens.

15. A cement board according to claim 14, further comprising a second facing sheet joined to a second surface portion of the cementitious core opposite the first surface portion.

16. A cement board according to claim 14, wherein the cementitious composition is a polymer concrete.

17. A cement board according to claim 14, wherein the yarns of the scrim are glass fibers.

18. A cement board according to claim 17, wherein the scrim has less than about 155,000 mesh openings per square meter.

19. A cement board according to claim 17, wherein the yarns in the scrim are joined at their crossover points by a polymeric binder.

20. A cement board according to claim 14, wherein the polymer film is a thermoplastic material.

21. A cement board according to claim 14, wherein the polymer film is a gravure printed film.

22. A cement board according to claim 14, wherein the openings of the polymer film are sufficiently large to allow passage of moisture during the hardening of the cementitious composition.

23. A cement board according to claim 14, wherein the basis weight of the polymer film is between about 10 and 60 g/m².

24. A cement board according to claim 14, wherein a distance between lines of the polymer film is between about 1 mm and 12 mm.

25. A method of manufacturing a facing sheet for an object comprising a hardened cementitious composition, comprising the steps of:
joining a plurality of intersecting yarns to create a scrim defining an open mesh pattern wherein the scrim includes an inner face defining a grid profile for mechanical interaction with the cementitious composition and an outer face opposite the inner face;
forming a polymer film such that the polymer film defines a repeating pattern of openings therein; and
joining the polymer film to the outer face of the scrim such that the joined polymer film and scrim define the facing sheet.

26. A method according to claim 25, wherein the joining a plurality of intersecting yarns step includes the application of a polymeric binder at crossover points of the intersecting yarns.

27. A method according to claim 25, wherein the joining a plurality of intersecting yarns step includes the weaving of the intersecting yarns to create the scrim.

28. A method according to claim 25, wherein the forming step is a gravure rolling process further comprising a step of gravure rolling heated polymer to create the polymer film.

29. A method according to claim 28, wherein the joining the polymer film and scrim step includes transferring the polymer film from the gravure rolling process to an intermediate surface and then transferring the polymer film from the intermediate surface to the outer face of the scrim.

30. A method according to claim 28, wherein the joining the polymer film and scrim step includes directly applying the polymer film from the gravure rolling process to the outer face of the scrim.

31. A method according to claim 28, wherein the forming a polymer film step includes spraying of an adhesive onto a surface of the polymer such that the adhesive joins the polymer film to the outer face of the scrim.

32. A method of manufacturing an object comprising a reinforced cementitious composition, comprising the steps of:
joining a polymer film having a repeating pattern of openings to an outer face of a scrim having a plurality of intersecting yarns defining an open mesh pattern such that the joined polymer film and scrim define a facing sheet, wherein the scrim includes an inner face defining a grid profile for mechanical interaction with the cementitious composition;
applying the facing sheet to a cementitious composition such that the inner face of the scrim engages a surface portion of the cementitious composition and the polymer film facilitates the mechanical interaction between the grid profile of the scrim and the cementitious composition; and
hardening the cementitious composition.

33. A method according to claim 32, wherein the joining step includes forming the polymer film by a gravure rolling process and transferring the polymer film to an intermediate surface and then further transferring the polymer film from the intermediate surface to the outer face of the scrim.

34. A method according to claim 32, wherein the hardening step includes allowing the passage of moisture from the cementitious composition through the openings of the polymer film.

35. A method according to claim 32, further comprising the step of applying a second facing sheet to a side of the cementitious composition opposite the first facing sheet.

36. A method of manufacturing an object comprising a reinforced cementitious composition, comprising the steps of:
forming a cementitious core from a cementitious composition that hardens to define the core;
advancing a scrim having a plurality of intersecting yarns defining an open mesh pattern and having an inner face defining a grid profile, said advancing step occurring such that the grid profile mechanically interacts with the cementitious composition before the cementitious composition is hardened;
advancing a polymer film having a repeating pattern of openings, such that the polymer film facilitates the mechanical interaction between the grid profile of the scrim and the surface portion of the cementitious composition; and
hardening the cementitious composition.

37. A method according to claim 36, wherein the advancing a polymer film step includes forming the polymer film by a gravure rolling process.

38. A method according to claim 36, wherein the hardening step includes allowing the passage of moisture from the cementitious composition through the openings of the polymer film.

39. A method according to claim 36, further comprising the step of advancing a second scrim onto a second surface portion of the cementitious composition opposite the first surface portion and advancing a second polymer film onto the second surface portion of the cementitious composition, such that the second polymer film joins a face of the second scrim opposite an inner face of the second scrim defining a second grid profile and facilitates the mechanical interaction between the second grid profile of the second scrim and the cementitious composition of the second surface portion.
